(19) United States
(12) Patent Application Publication
(10) Pub. No.: US 2011/0005121 A1
(43) Pub. Date: Jan. 13, 2011

(54) Fishing lure neodymium magnetized holder

(76) Inventor: Edward Carl Gelber, Coral Gables, FL (US)

Correspondence Address: Robert J. Van Der Wall;Grand Bay Plaza, Suite 701, 2665 South Bayshore Drive, Coconut Grove, FL, 33133, US

(21) Appl. No.: 12/459,674

(22) Filed: Jul. 7, 2009

(51) Int. Cl. A01K 97/06

(52) U.S. Cl. 43/57.1; 43/54.1

(57) ABSTRACT

A fishing lure neodymium magnetized holder is disclosed including an array of neodymium magnets attached to a flat sheet of iron or steel, preferably iron. The flat sheet of iron and neodymium magnets are housed in a moisture impervious enclosure preferably comprised of a combination of plastic box and a sealed cover of polyurethane or similar durable moisture impervious material attached to the top surface of the flat sheet of iron to completely isolate and protect the flat sheet of iron and neodymium magnets from moisture and resulting corrosion. Preferably, four suction cups are attached to four threaded studs. The threaded studs are then threaded into four receptacle members fixedly attached near the four rear corners of the flat plastic box. The four suction cups allow the holder to be placed and held in any convenient location on smooth surfaces that abound in molded fishing boats. The magnetic attracting force of the neodymium magnets is so powerful that it can penetrate the polyurethane or similar moisture impervious material attached to the top surface of the flat iron sheet and still retain the fishing lures and other fishing accessories securely and safely in any position on the flat surface of the inventive holder.

### BACKGROUND OF THE INVENTION

1. Field of the Invention

The present invention relates to the field of sport fishing accessories. It particularly concerns a novel way of safely retaining and displaying fishing lures for easy selection and removal from the inventive holder. It is made possible only as a result of the use of neodymium magnets, which are very much stronger than conventional magnets in their ability to attract metal such as steel fish hooks because the magnets and a metal plate must be covered with a moisture impervious layer to protect them from corrosion or rust.

The present invention contemplates the use of a flat structure on which the lures are placed, thus avoiding complicated structures found in the prior art. This leads to several advantages over the prior art, namely any size or shape of lure can be attached anywhere on the surface, any other fishing accessory having steel surfaces such scissors and knives of any shape or size can also be attached for quick and convenient use, the magnets' benefits can be magnified by being attached to a flat sheet of iron or steel, preferably iron, that is entirely protected from corrosion by being encased in a combination of a moisture impervious plastic flat box covered on the top by polyurethane or a similar durable moisture impervious layer, the lures can be easily attached and removed without manipulation because of the absence of complicated surface structures, and the lures are protected from damage resulting from contact with a metal surface, since they only contact the polyurethane or a similar durable moisture impervious layer.

2. Description of the Prior Art

It is well known in the art that the relentless and eternal enemy of the sport fishing tackle box is corrosion or rust. That statement is true even if the tackle that it contains is only employed for fresh water sport fishing. But it is very much more so for salt water sport fishing tackle boxes. And those statements apply equally to fishing accessories that may be too large to fit in a tackle box if they have iron or steel surfaces. Fish hooks are, of course, made from steel because they must be able to withstand very high forces imposed on them by fish who believe they are fighting for their lives.

It is known in the art that magnets have been used to retain fishing lures. See, for example, Haase, U.S. Patent No. D286,425. But so far as is known to Applicant, these magnets are conventional and are only used “naked” without being protected from corrosion by a moisture impervious layer. That is logically because conventional magnets lack sufficient attracting strength to be effective through a protective moisture impervious layer such as a polyurethane coating. Other prior art lacking in the use of magnets at all are Barnes, U.S. Pat. No. 4,208,825, Fliegelman, U.S. Pat. No. 4,081,116, O'Reilly, U.S. Pat. No. 4,015,361, Lawless, U.S. Pat. No. 3,949,873, Rowe, U.S. Pat. No. 3,800,456, Smallwood, U.S. Pat. No. 3,797,161, and Wolfrum, U.S. Pat. No. 3,430,379.

Most of these prior art references contain complicated surface structures concerning which the fishing lures must be manipulated. The present invention uses a flat surface which is substantially uniformly magnetized using powerful neodymium magnets. But the flat surface to which the fishing lures are attached is not metal, it is a durable moisture impervious layer through which the magnetic force penetrates. This is only made possible by the use of the powerful neodymium magnets. The use of a flat surface makes the aforesaid manipulation of the fishing lures completely unnecessary, thereby making attachment and removal of the fishing lures much easier than in the prior art, and making them much more visible for lure selection purposes. But the fishing lures are held securely in place because of the strength of the magnets, and are also protected from damage from contact with a metal surface because the durable moisture impervious layer is not metal.

### SUMMARY OF THE INVENTION

Bearing in mind the foregoing, a principal object of the present invention is to provide a flat surface for the attachment,. display, retention, selection, and removal of a plurality of fishing lures.

Another principal object of the present invention is to provide a flat surface for easy attachment and removal of fishing lures of any shape or size anywhere on the surface and with no complicated surfaces involving manipulation of the lures when they are being attached and removed as is common with the prior art.

An additional principal object of the present invention is to employ neodymium magnets to achieve the magnetic strength sufficient to hold in place on a flat surface of a durable moisture impervious layer an infinite variety of fishing lures of any size or shape and other fishing accessories having steel surfaces such a scissors and knives.

A further principal object of the present invention is to employ a flat sheet of iron to maximize the benefits of the neodymium magnets because iron is the most strongly magnetizable substance.

Another principal object of the present invention is to completely protect the magnets and the sheet of iron from corrosion by encasing both of them entirely with a moisture impervious material layer such as a plastic box with a polyurethane sealed cover.

An additional principal object of the present invention is protect the fishing lures from damage resulting from contact with a metal surface as is otherwise normally necessary when using magnetism to retain fishing lures.

A further object of the present invention is to provide an appropriate means to attach the flat surface of the holder to any convenient smooth surface near the user by having a suction cup mounting apparatus on the back of the holder.

Other object and advantages of the present invention will be apparent to those skilled in the art upon reference to the following descriptions taking in combination with the appended drawings.

In accordance with a principal aspect of the invention there is provided a plurality of neodymium magnets attached to a flat sheet of iron or steel, preferably iron. The flat sheet of iron and neodymium magnets are housed in a moisture impervious enclosure preferably comprised of a combination of plastic box and a sealed cover of polyurethane or similar durable moisture impervious material attached to the top surface of the flat sheet of iron to completely isolate and protect the flat sheet of iron and neodymium magnets from moisture and resulting corrosion. Preferably, four suction cups are attached to four threaded studs. The threaded studs are then threaded into four receptacle members fixedly attached near the four rear corners of the flat plastic box. The four suction cups allow the holder to be placed and held in any convenient location on smooth surfaces that abound in molded fishing boats. The magnetic attracting force of the neodymium magnets is so powerful that it can penetrate the polyurethane or similar moisture impervious material attached to the top surface of the flat iron sheet and still retain the fishing lures and other fishing accessories securely and safely in any position on the flat surface of the inventive holder.

### BRIEF DESCRIPTION OF THE DRAWINGS

Various other features of the invention will become apparent to those skilled in the art from the following discussion taken in conjunction with the appended drawings, in which:

FIG. 1 is a perspective view of the preferred embodiment of the present invention showing the fully assembled fishing lure neodymium magnetized holder to which have been attached by magnetic attraction various fishing lures plus other fishing accessories such as scissors and a knife.

FIG. 2 is an opened view of the apparatus of FIG. 1 showing an array of neodymium magnets attached to the back of the flat iron sheet and four suction cups in phantom on the back of the plastic box.

FIG. 3 is a left end view of the apparatus of FIG. 1 showing the suction cups attached to the rear side of the plastic box seen in both FIGS. 1 and 2.

### DETAILED DESCRIPTION OF THE PREFERRED EMBODIMENT

As required, a detailed embodiment of the present invention is disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

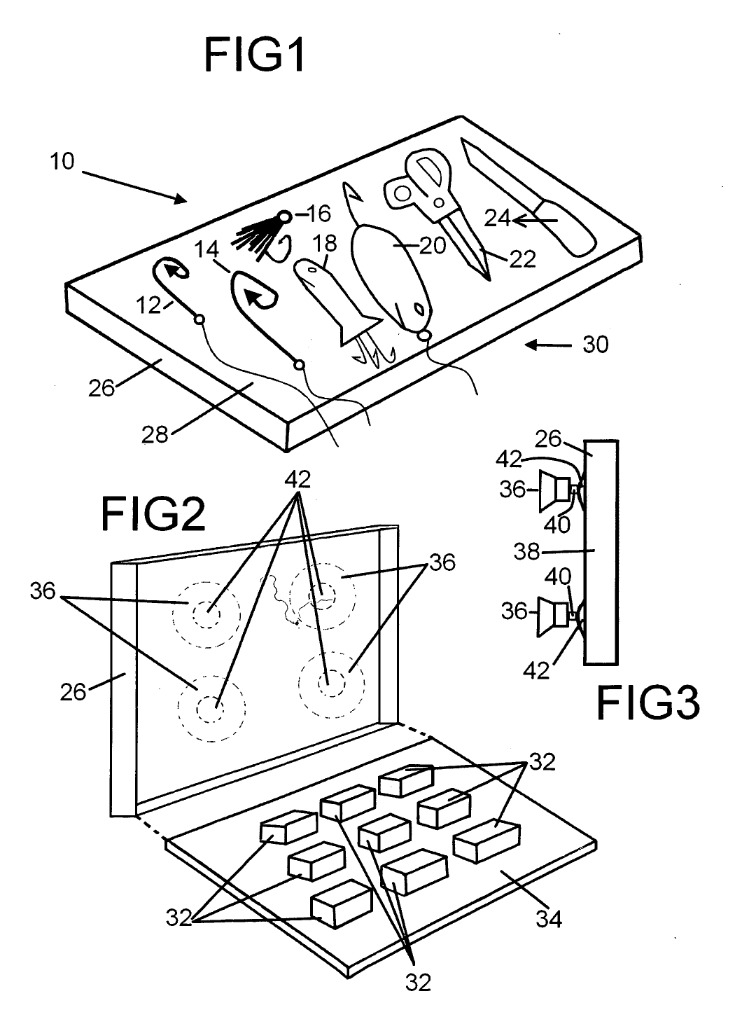

FIG. 1 is a perspective view of the preferred embodiment of the present invention showing the fully assembled fishing lure neodymium magnetized holder 10 to which have been attached by magnetic attraction various fishing lures 12, 14, 16, 18 and 20 plus other fishing accessories such as scissors 22 and a knife 24. The fishing lure neodymium magnetized holder 10 is comprised of a moisture impervious plastic box 26 and flat iron sheet (seen in FIG. 2) covered with a durable moisture impervious layer 28. The plastic box 26 and durable moisture imprevious layer are sealed to each other to form a moisture impervious housing 30.

FIG. 2 is an opened view of the apparatus of FIG. 1 showing an array of neodymium magnets 32 attached to the back of the flat iron sheet 34 and four suction cups 36 in phantom on the back of the plastic box 26.

FIG. 3 is a left end view of the apparatus 10 of FIG. 1 showing the suction cups 36 attached to the rear side 38 of the plastic box 26 seen in both FIGS. 1 and 2. The suction cups 36 are attached to threaded studs 40, which in turn are removably attached to receptacle members 42 fixedly attached near the four rear corners of the flat plastic box 26.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A fishing lure neodymium magnetized holder comprising:
a flat magnetizable metal sheet;
at least one neodymium magnet attached to and magnetizing the metal sheet;
a flat moisture impervious box; and
a durable moisture impervious layer attached to the metal sheet and sealed to the flat moisture impervious box to make a moisture impervious housing for the metal sheet and magnet(s).

2. The fishing lure neodymium magnetized holder of claim 1 which further comprises an array of the neodymium magnets to substantially uniformly magnetize the flat metal sheet.

3. The fishing lure neodymium magnetized holder of claim 1 in which the flat iron metal sheet is comprised of iron.

4. The fishing lure neodymium magnetized holder of claim 1 in which the durable moisture impervious layer attached to the metal sheet and sealed to the flat moisture impervious box is polyurethane.

5. The fishing lure neodymium magnetized holder of claim 1 in which the flat moisture impervious box is a plastic box.

6. The fishing lure neodymium magnetized holder of claim 1 which further comprises a suction cup mounting apparatus on the back of the holder.

7. The fishing lure neodymium magnetized holder of claim 6 which further comprises four suction cups attached to threaded studs which in turn are removably attached to receptacle members that are fixedly attached near the four rear corners of the flat moisture impervious box.

8. A fishing lure neodymium magnetized holder comprising:
a flat iron sheet;
a array of neodymium magnets attached to and substantially uniformly magnetizing the iron sheet;
a flat moisture impervious plastic box;
a durable moisture impervious layer such as polyurethane attached to the iron sheet and sealed to the flat moisture impervious plastic box to make a moisture impervious housing for the iron sheet and magnet; and
a suction cup mounting apparatus having four suction cups attached to threaded studs which in turn are removably attached to receptacle members that are fixedly attached near four rear corners of the flat moisture impervious plastic box.
